(19) United States
(12) Patent Application Publication
(10) Pub. No.: US 2019/0118850 A1
(43) Pub. Date: Apr. 25, 2019

(54) STEERING DEVICE

(71) Applicant: HONDA MOTOR CO., LTD., Minato-ku, Tokyo (JP)

(72) Inventor: Shotaro Odate, Wako-shi, Saitama-ken (JP)

(21) Appl. No.: 16/088,974

(22) PCT Filed: Mar. 29, 2016
(86) PCT No.: PCT/JP2016/060093

§ 371 Date: Sep. 27, 2018

(51) Int. Cl. B62D 1/04; B62D 1/06; G01V 3/08

(52) U.S. Cl. CPC B62D 1/046; G01V 3/08; B62D 1/06

(57) ABSTRACT

In order to make it possible to definitively restrict operation of an in-vehicle device by a passenger who is driving a vehicle, by using a simple and economic configuration, a steering device is equipped with a steering wheel and a detection mechanism. The detection mechanism has a first contact sensor that detects contact with the left hand of a driver, and is provided on the side near the in-vehicle device, and also has a second contact sensor that detects contact with the right hand, and is provided on the side away from the in-vehicle device. The detection range of the first contact sensor is set as a narrower region than that of the detection range of the second contact sensor.

### TECHNICAL FIELD

The present invention relates to a steering device equipped with a steering wheel, and a detection mechanism adapted to detect contact of the hands of a vehicle occupant over a predetermined region on the circumference of the steering wheel.

### BACKGROUND ART

In recent years, various systems have been adopted in automobiles in order to discriminate whether or not the hands of a driver are grasping the steering wheel. For example, a vehicle attention arousing system for a vehicle is known, as disclosed in Japanese Laid-Open Patent Publication No. 2008-059459.

In such a vehicle attention arousing system, a plurality of contact sensors (wires or the like) are arranged over the entire circumference of the steering wheel (paragraph [0054]). In addition, the contact sensors are insulated via insulating bodies at a 12 o'clock position and a 6 o'clock position, and contact with an L (left) side and an R (right) side of the steering wheel is partitioned and detected by an L-side contact detection means and an R-side contact detection means.

Thus, for example, in a state in which contact is detected on both the L-side and the R-side, or stated otherwise, in a state in which it is presumed that the driver is grasping the steering wheel with both hands, there are cases in which the above-described vehicle attention arousing system is applied to a system that allows vehicle-mounted devices to be operated even while traveling.

At such a time, in the vehicle attention arousing system, spaces between the L-side contact detection means and the R-side contact detection means, which are insulated via the insulating bodies, is narrow. In addition, boundaries between the L-side and R-side detection regions are positioned on a vertical center line of the steering wheel in an upright position of the steering wheel (a position in which the vehicle travels straight ahead). Therefore, in the case that the driver grasps the boundary that is positioned at 12 o'clock with one hand (one of the hands), there is a concern that it will be recognized erroneously that the steering wheel is being grasped with both hands, and the driver is made capable of operating the vehicle-mounted device with the other hand.

### SUMMARY OF INVENTION

The present invention has been devised in order to solve this type of problem, and has the object of providing, with a simple and economical structure, a steering device which is capable of reliably restricting operations of a vehicle-mounted device by a vehicle occupant while the vehicle is being driven.

The present invention relates to a steering device equipped with a steering wheel, and a detection mechanism configured to detect contact by hands of a vehicle occupant over a predetermined region on a circumference of the steering wheel.

The detection mechanism includes a first contact sensor provided on a side proximate to a vehicle-mounted device as viewed from a front of the steering wheel, and configured to detect contact by one hand of the vehicle occupant. The detection mechanism further includes a second contact sensor provided on a side remote from the vehicle-mounted device, and configured to detect contact by another hand of the vehicle occupant. In addition, a first detection range detected by the first contact sensor is set to a region that is narrower than a second detection range detected by the second contact sensor.

Further, on an upper half of the steering wheel, a boundary between the first detection range and the second detection range may preferably be disposed on a side proximate to the vehicle-mounted device with respect to a vertical center line of the steering wheel.

Furthermore, on a lower half of the steering wheel, a boundary between the first detection range and the second detection range may preferably be disposed on a side proximate to the vehicle-mounted device with respect to a vertical center line of the steering wheel.

Further still, preferably, leather members by which the predetermined region is divided in plurality along the circumference may be wound around the steering wheel. At that time, a conductive paint may preferably be applied to each of the leather members, thereby constituting a first touch sensor and a second touch sensor as the first contact sensor and the second contact sensor, respectively.

According to the present invention, the first detection range that detects one hand of the vehicle occupant (driver) is disposed on the side proximate to the vehicle-mounted device, and is set to a region that is narrower than the second detection range that detects the other hand of the vehicle occupant. Accordingly, at least one of the boundaries between the first contact sensor and the second contact sensor is arranged at a position proximate to the vehicle-mounted device, and at a position that can be easily grasped by one hand of the vehicle occupant.

Therefore, in spite of a state in which only one hand of the vehicle occupant is grasping the boundary between the first contact sensor and the second contact sensor, even in the case it is presumed by the detection mechanism that both hands of the vehicle occupant are in contact with the steering wheel, since the boundary is grasped by the one hand on the side proximate to the vehicle-mounted device, it is difficult for the vehicle-mounted device to be operated with the other hand.

Accordingly, with a simple and economical structure, even if the detection mechanism determines erroneously that the driver is grasping the steering wheel with both hands, and the operation of the vehicle-mounted device is enabled during traveling, it is possible to reliably prevent operation of the vehicle-mounted device.

### BRIEF DESCRIPTION OF DRAWINGS

FIG. 1 is a schematic configuration diagram of a vehicle in which a steering device according to an embodiment of the present invention is installed;

FIG. 2 is a block diagram showing a detailed configuration of the steering device;

FIG. 3 is an explanatory diagram of a driver's seat side of the vehicle;

FIG. 4 is an explanatory diagram of a steering wheel and a detection mechanism that constitute the steering device;

FIG. 5 is a flowchart for describing operations of the steering device; and

FIG. 6 is an explanatory diagram of a driver's seat side of a vehicle when a first contact sensor and a second contact sensor are grasped simultaneously with the left hand.

### DESCRIPTION OF EMBODIMENTS

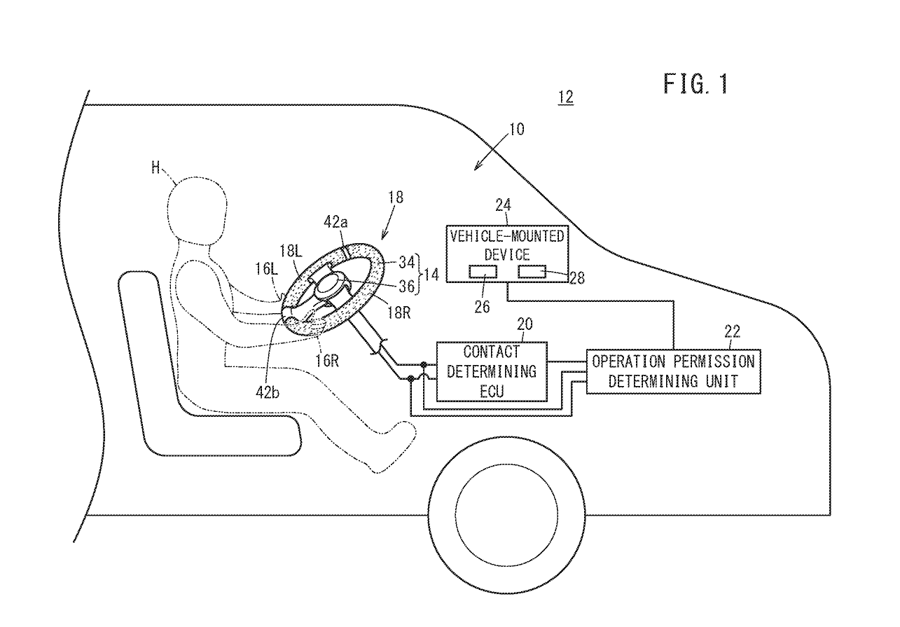

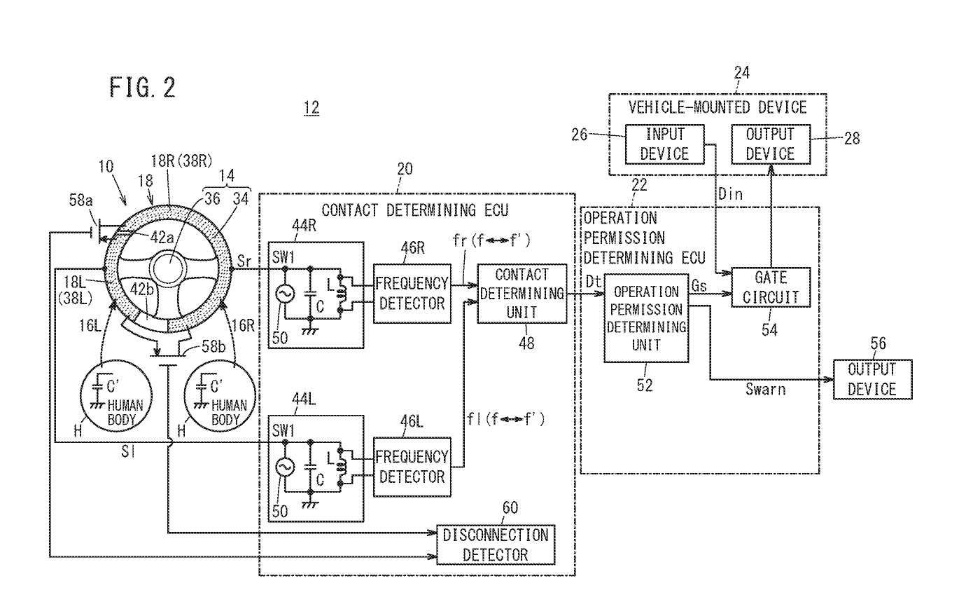

As shown in FIGS. 1 and 2, a steering device 10 according to an embodiment of the present invention is installed in a vehicle 12 such as an automobile or the like.

The steering device 10 is equipped with a steering wheel 14, which is an operating member for manipulating a direction in which the vehicle 12 travels, and a detection mechanism 18 that detects contact by both hands (a right hand 16R and a left hand 16L) of a driver H over a predetermined region on the circumference of the steering wheel 14.

A contact determining ECU (Electronic Control Unit) 20 is electrically connected to the steering wheel 14, and an operation permission determining ECU 22 is electrically connected to both the steering wheel 14 and the contact determining ECU 20.

A well-known type of computer is applied to the contact determining ECU 20 and the operation permission determining ECU 22. The contact determining ECU 20 and the operation permission determining ECU 22 include a computation unit, a storage unit, an input/output unit, and a counter/timer, etc., none of which are shown. By the computation unit executing programs stored in the storage unit, various function realizing units are constructed, which are needed in order to carry out the contact determination and the operation permission determination, respectively. The function realizing units can also be constituted in the form of hardware.

The vehicle 12 is equipped with a vehicle-mounted device 24 such as a navigation device, an air conditioning device, an audio device, or the like, which is not concerned with the basic performance (traveling, turning, stopping) of the vehicle 12, and which can be operated by the vehicle occupants (a driver and a fellow passenger).

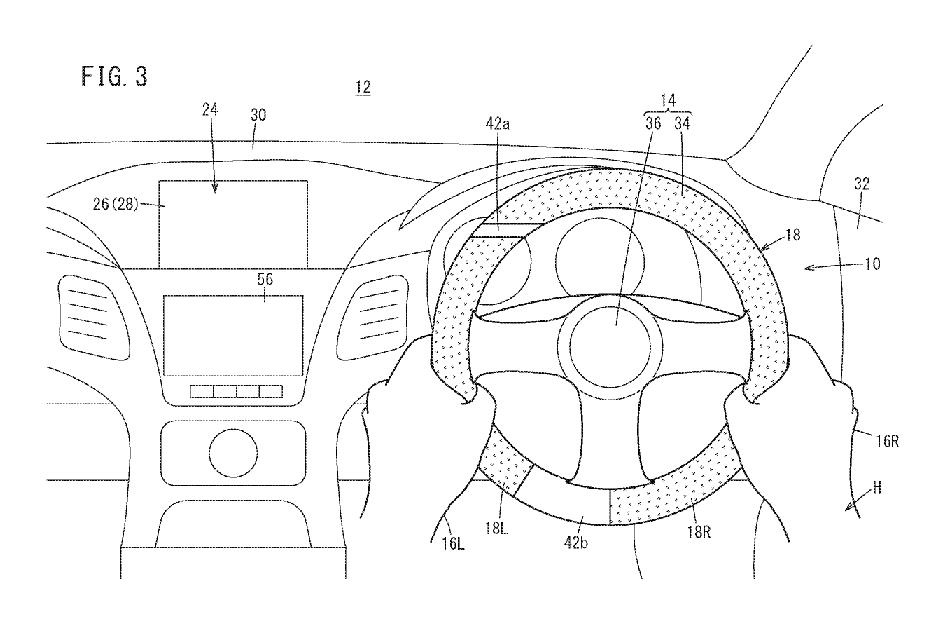

As shown in FIG. 3, an input device 26 such as a touch panel, a switch, a volume knob, or the like of the vehicle-mounted device 24 is disposed in the vicinity of a substantially central portion of a dashboard 30 of the vehicle 12. The steering wheel 14, for example, is a right-hand steering wheel, and the vehicle-mounted device 24 is arranged on one side (the left side in FIG. 3) of the steering wheel 14 when the vehicle 12 is observed in plan view. A front door 32 faces toward another side (the right side) of the steering wheel 14.

The steering wheel 14 is manipulated by the driver H. The input device 26 of the vehicle-mounted device 24 is capable of being operated not only by the driver H but also by the fellow passenger. The operation permission determining ECU 22 is provided in order to restrict the driver H from operating the vehicle-mounted device 24 while the vehicle 12 is traveling.

As shown in FIGS. 1 and 2, the steering wheel 14 is formed in an annular shape, and includes a rim portion 34 for the driver H to grasp with the right hand 16R and the left hand 16L. In an upright position of the steering wheel 14 (a position in which the vehicle 12 travels straight ahead), radial inner sides of left and right and lower parts of the rim portion 34 and the steering shaft are connected by a T-shaped connecting part 36.

The rim portion 34 is configured in the form of a laminated structure the cross section of which is made up from a plurality of layers. More specifically, the rim portion 34 comprises, in order toward a side in a radial outward direction from a cross-sectional center portion thereof, an annular metal core (not shown), a molded layer (not shown) made of a resin material, and a plurality of (for example, two or four) leather layers 38L, 38R. The core constitutes the skeletal structure of the rim portion 34, and is connected to the steering shaft via a connecting member provided inside the connecting part 36.

The leather layers 38L, 38R are wound around the outer circumference of the molded layer with a plurality of leather members being adjacent to each other, respectively, so that the leather members are wound over a predetermined region on the entire circumference of the steering wheel. A first contact sensor (first touch sensor) 18L and a second contact sensor (second touch sensor) 18R are constituted by applying a conductive paint to each of the leather members. The first contact sensor 18L and the second contact sensor 18R constitute the detection mechanism 18.

As shown in FIG. 3, the first contact sensor 18L is provided on a side proximate to the vehicle-mounted device 24 as viewed from the front of the steering wheel 14, and detects contact by the left hand (one hand) 16L of the driver H. The second contact sensor 18R is provided on a side remote from the vehicle-mounted device 24 as viewed from the front of the steering wheel 14, and detects contact by the right hand (other hand) 16R of the driver H.

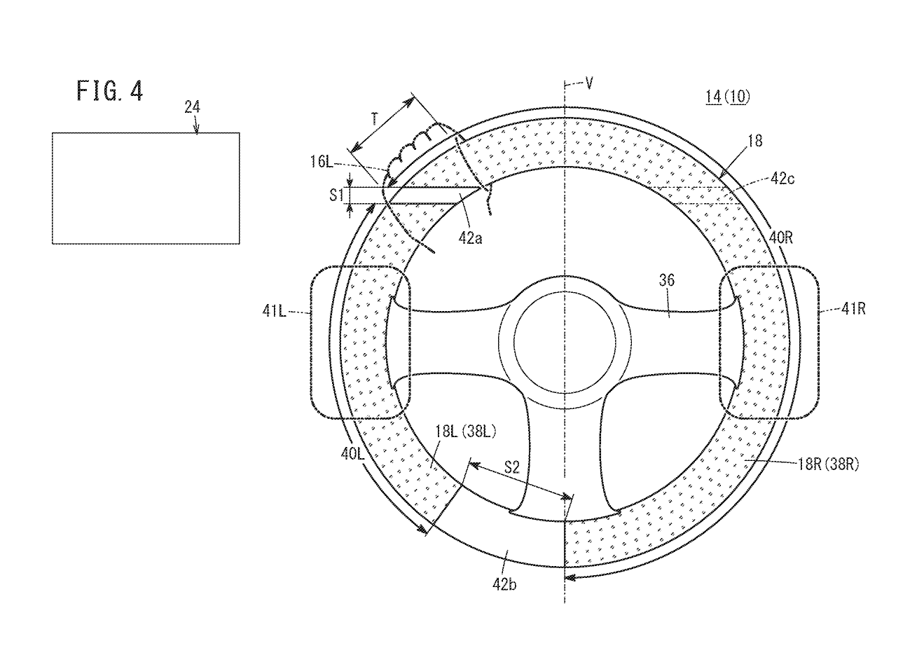

As shown in FIG. 4, a first detection range 40L detected by the first contact sensor 18L is set to a region that is narrower than a second detection range 40R detected by the second contact sensor 18R. The first detection range 40L lies within a range that includes a vertical region 41L corresponding to a 9 o'clock position of the steering wheel 14 (a boundary site with a left end portion of the connecting part 36). The second detection range 40R lies within a range that includes a vertical region 41R corresponding to a 3 o'clock position of the steering wheel 14 (a boundary site with a right end portion of the connecting part 36).

On an upper half of the steering wheel 14, an upper boundary 42a between the first detection range 40L and the second detection range 40R is disposed on a side proximate to the vehicle-mounted device 24 with respect to a vertical center line V of the steering wheel 14. The first detection range 40L and the second detection range 40R lie adjacent to each other, and the upper boundary 42a is separated by a space S1, which is of a degree so that the driver H is capable of contacting the first detection range 40L and the second detection range 40R at the same time with one hand (left hand 16L). For example, the space S1 of the upper boundary 42a is set to a dimension that is less than a width T (see FIG. 4) of a first of the left hand 16L of the driver H (S1<T).

On a lower half of the steering wheel 14, a lower boundary 42b between the first detection range 40L and the second detection range 40R is disposed on the side proximate to the vehicle-mounted device 24 with respect to the vertical center line V of the steering wheel 14. The lower boundary 42b is separated by a space S2, which is of a degree so that the driver H is incapable of contacting the first detection range 40L and the second detection range 40R at the same time with one hand (the left hand 16L or the right hand 16R). For example, the space S2 of the lower boundary 42b is preferably set to a dimension that is greater than the width T of a first of the left hand 16L of the driver H (S2>T).

An insulation treatment is implemented on the upper boundary 42a and the lower boundary 42b in order to electrically isolate the first detection range 40L and the second detection range 40R. The insulation treatment is carried out, for example, by providing portions on the leather layers 38L, 38R to which the conductive coating is not applied, or by applying insulating members (insulating materials) on the leather layers 38L, 38R. Alternatively, the insulating treatment is performed by interposing insulating members between the leather layers 38L, 38R.

An electrostatic capacitance sensor, which is capable of detecting an electrostatic capacitance in the case that the driver H (human body) has grasped and contacted the steering wheel 14, and an electrostatic capacitance in the case that the driver H (human body) is not in contact with the steering wheel 14, is used as each of the first contact sensor 18L and the second contact sensor 18R.

As shown in FIG. 2, a contact signal S1 and a contact signal Sr, which are output from the first contact sensor 18L and the second contact sensor 18R, are supplied respectively to an oscillation circuit 44L and an oscillation circuit 44R in the contact determining ECU 20. Outputs from the oscillation circuit 44L and the oscillation circuit 44R are connected to a frequency detector (oscillation frequency detector) 46L and a frequency detector 46R.

An oscillation frequency fl pertaining to the first contact sensor 18L for the left hand as detected by the frequency detector 46L, and an oscillation frequency fr pertaining to the second contact sensor 18R for the right hand as detected by the frequency detector 46R are supplied respectively to two input ports of a contact determining unit 48. Each of the oscillation circuits 44L, 44R includes an oscillator main body 50, and a resonant circuit including an electrostatic capacitance C and an inductance L.

As shown in the following equations (1) and (2), the frequency detectors 46L, 46R, which are frequency counters, separately detect an oscillation frequency f, which is a resonant frequency (electrostatic capacitance C) when the driver H is not touching the detection mechanism 18 with the left hand 16L and the right hand 16R, and an oscillation frequency f′, which is a resonant frequency when the electrostatic capacitance (C+C′) has increased when the detection mechanism 18 is touched.

non-contact: f=½π(L×C)^{1/2} (1)

contact: f′=½π{L×(C+C′)}^{1/2} (2)

In equations (1) and (2), the electrostatic capacitance C′ is an electrostatic capacitance of the driver (human body) H.

The frequency detector 46L detects the oscillation frequency fl when the left hand 16L has contacted the first contact sensor 18L as the oscillation frequency f′, and detects the oscillation frequency fl at a time of non-contact as the oscillation frequency f.

The frequency detector 46R detects the oscillation frequency fr when the right hand 16R has contacted the second contact sensor 18R as the oscillation frequency f′, and detects the oscillation frequency fr at a time of non-contact as the oscillation frequency f.

For example, in the case that the LC resonant frequency is set to several hundred kHz or the like, a frequency difference (f>>f′) of several tens of kHz is obtained by the contact and non-contact states, and it is possible to sufficiently distinguish between the contact and non-contact states.

The contact determining unit 48 detects the contact and non-contact states of the left hand 16L and the right hand 16R to the first contact sensor 18L and the second contact sensor 18R, from the oscillation frequency fr (non-contact: f, contact: f′) and the oscillation frequency fl (non-contact: f, contact: f′) supplied to the respective input ports, and outputs the detection result as a contact determination output Dt.

The contact determination output Dt is supplied to the input port of an operation permission determining unit 52 that constitutes the operation permission determining ECU 22. A gate signal Gs, which is an output from the operation permission determining unit 52, is input to a control port which is one input port of a gate circuit 54. An input signal Din, which is an operation input by the driver H to the input device 26 that makes up the vehicle-mounted device 24, is supplied to a signal input port which is another input port of the gate circuit 54.

When an “H level” (permission granted) of the gate signal Gs, which is an output of the operation permission determining unit 52, is input to the control port, the gate circuit 54 passes through and outputs the input signal Din that is input to the signal input port. On the other hand, when an “L level” (permission not granted) of the gate signal Gs, which is an output of the operation permission determining unit 52, is input to the control port, the gate circuit 54 interrupts the input signal Din that is input to the signal input port.

The output of the gate circuit 54 is supplied to an output device 28 including a main body portion and a display unit of the vehicle-mounted device 24. A warning signal (notification signal) Swarn is output from the operation permission determining unit 52 to an output device 56 (a display device and a speaker) of a display audio device or the like. The output device 56 functions as a warning device (notification device).

An FET (field effect transistor) 58a, which is connected across the upper boundary 42a to the first contact sensor 18L and the second contact sensor 18R, is connected to the steering wheel 14. An FET 58b, which is connected across the lower boundary 42b to the first contact sensor 18L and the second contact sensor 18R, is connected to the steering wheel 14. The FETs 58a, 58b are connected to a disconnection detector 60, and detect disconnections of the first contact sensor 18L and the second contact sensor 18R.

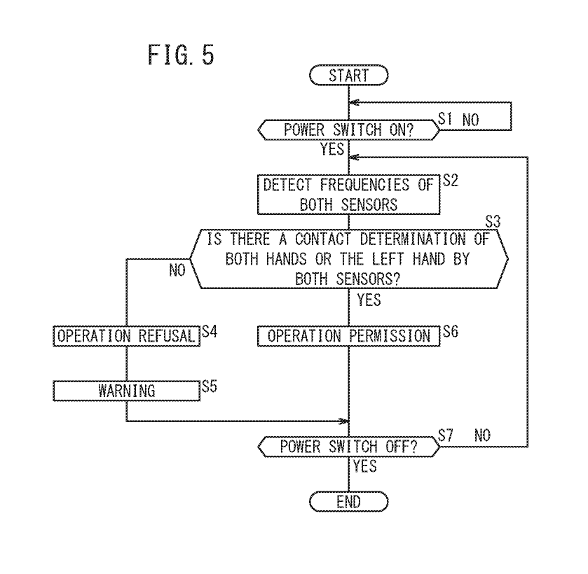

Operations of the steering device 10, which is configured in the foregoing manner, will be described with reference to the flowchart of FIG. 5.

In step S1, the contact determining ECU 20 and the operation permission determining ECU 22 detect that a non-illustrated power switch (ignition switch) of the vehicle 12 has been placed in an ON state (YES in step S1).

Next, proceeding to step S2, the operation permission determining unit 52 detects from the frequency detectors 46L, 46R the oscillation frequency fl and the oscillation frequency fr of the first contact sensor 18L and the second contact sensor 18R.

In step S3, the contact determining unit 48 refers to the oscillation frequencies f, f′ of the oscillation frequency fl and the oscillation frequency fr {the above-described equation (1) and equation (2)}, and performs a contact determination with respect to the first contact sensor 18L of the left hand 16L, and a contact determination with respect to the second contact sensor 18R of the right hand 16R.

More specifically, contact determinations are carried out on the basis of the following map (contact determination map), in which a one-hand contact determination or a two-hand contact determination made with respect to the detection mechanism 18 (first contact sensor 18L and second contact sensor 18R) is expressed using combinations of the oscillation frequencies [fl, fr].

### (Contact Determination Map)

[fl=f, fr=f]→left hand 16L: non-contact, right hand 16R: non-contact
[fl=f, fr=f′]→left hand 16L: non-contact, right hand 16R: contact
[fl=f′, fr=f]→left hand 16L: contact, right hand 16R: non-contact
[fl=f′, fr=f′]→left hand 16L: contact, right hand 16R: contact
[fl=f′, fr=f′]→left hand 16L: simultaneous contact with both sensors

In the above-described contact determination map, determinations are made that the left hand 16L is in contact with the steering wheel 14 in the third, fourth, and fifth modes from the top.

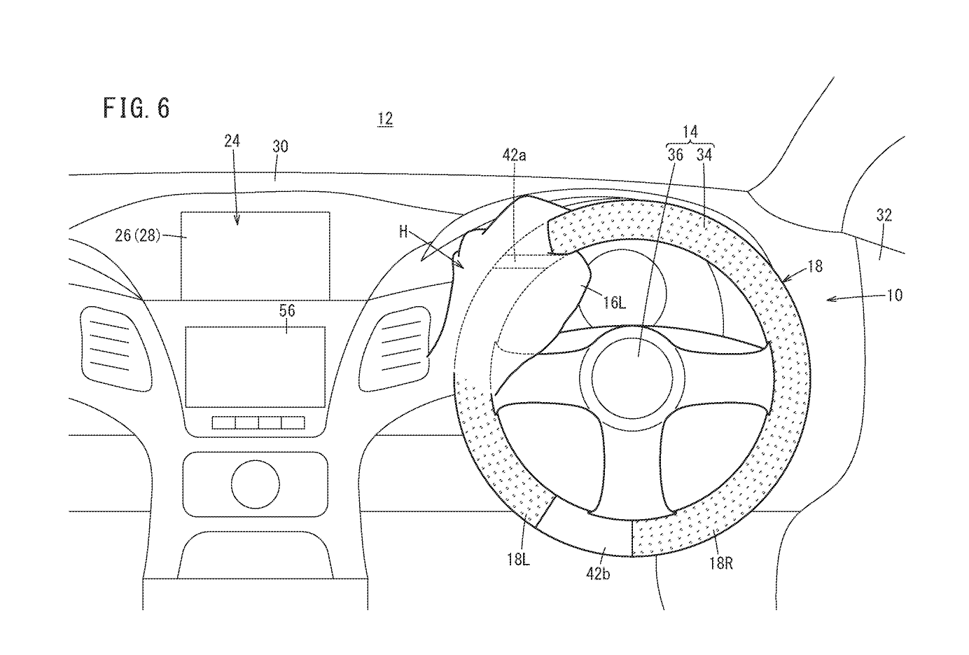

In the fifth mode, as shown in FIG. 6, the left hand 16L of the driver H is in a state of simultaneous contact with the first contact sensor 18L and the second contact sensor 18R while straddling across the upper boundary 42a. At such a time, the right hand 16R may not be in contact with the second contact sensor 18R.

When it is determined by the contact determination output Dt of the contact determining unit 48 that a two-handed contact is not taking place, and contact with the left hand is not occurring (NO in step S3), the process proceeds to step S4, and the operation permission determining unit 52 carries out an operation refusal process. At this time, the operation permission determining unit 52 outputs a gate signal Gs of an “L level” (permission not granted) to the gate circuit 54.

When the gate signal Gs of the “L level” (permission not granted) is input from the operation permission determining unit 52, the gate circuit 54 interrupts the input signal Din from the input device 26 of the vehicle-mounted device 24. Consequently, the output device 28 does not respond, and the vehicle-mounted device 24 is maintained in an operation refusal state (operation prohibited state).

After the operation refusal process of step S4, in step S5, the operation permission determining unit 52 outputs a warning signal (notification signal) Swarn with respect to the output device 56. Due to the warning signal (notification signal) Swarn, a possibility exists that the left hand 16L of the driver H is free. Accordingly, the output device 56 outputs a display or a voice message from the speaker to indicate that the vehicle-mounted device 24, for example, a navigation device, cannot be operated, and issues a warning (notification) to the vehicle occupant.

On the other hand, in step S3, when it is determined by the contact determination output Dt of the contact determining unit 48 that a two-handed contact or contact with the left hand is taking place (YES in step S3), the process proceeds to step S6. In step S6, the operation permission determining unit 52 outputs the gate signal Gs of an “H level” (permission granted) to the gate circuit 54.

When it is determined that the driver H is in a two-handed contact state or a left-handed contact state with respect to the steering wheel 14, the gate circuit 54 allows the input signal Din of the input device 26 to pass through, and outputs it to the output device 28. Therefore, operations of the vehicle-mounted device 24 made by the fellow passenger are treated as valid.

Next, proceeding to step S7, it is determined whether or not the power switch has been placed in an OFF state. If the power switch is not in an OFF state (NO in step S7), the routine returns to step S2 and process is continued. On the other hand, if the power switch is in an OFF state (YES in step S7), a determination is made to terminate the process.

In this case, according to the present embodiment, as shown in FIGS. 3 and 4, the first detection range 40L for detecting the left hand (one hand) 16L of the driver H is set to a region that is narrower than the second detection range 40R for detecting the right hand (other hand) 16R of the driver H. Therefore, the upper boundary 42a between the first contact sensor 18L and the second contact sensor 18R is arranged at a position that can be easily grasped by the left hand 16L of the driver H. Accordingly, there are cases in which the left hand 16L simultaneously grasps the first contact sensor 18L and the second contact sensor 18R while straddling across the upper boundary 42a. On the other hand, the right hand 16R of the driver H is separated from the upper boundary 42a, and the upper boundary 42a is not grasped thereby.

Accordingly, when only the contact signal from the first contact sensor 18L is obtained, or when the contact signals are simultaneously obtained from the first contact sensor 18L and the second contact sensor 18R, it is determined that the left hand 16L is grasping the steering wheel 14. Consequently, input operations of the vehicle-mounted device 24 can be permitted.

On the other hand, in the case that there are no contact signals from the first contact sensor 18L or the second contact sensor 18R, or in the case that only a contact signal from the second contact sensor 18R is obtained, it is possible to restrict the input operations of the vehicle-mounted device 24. Consequently, with a simple and economical structure, it is possible to reliably restrict operations of the vehicle-mounted device 24 by the driver H while the vehicle is being driven.

More specifically, as shown in FIG. 4, on the upper half of the steering wheel 14, the upper boundary 42a between the first detection range 40L and the second detection range 40R is disposed on a side proximate to the vehicle-mounted device 24 with respect to the vertical center line V of the steering wheel 14. In addition, the space S1 of the upper boundary 42a is set to a dimension that is less than the width T of a first of the left hand 16L of the driver H.

Therefore, with the left hand 16L of the driver H, a posture is possible in which the first detection range 40L is grasped (see FIG. 3), and a posture is possible in which the first detection range 40L and the second detection range 40R are grasped simultaneously (see FIG. 6). In both of these postures, since the driver H cannot operate the vehicle-mounted device 24 with the right hand 16R, convenience can easily be enhanced by allowing the passenger in the passenger seat to operate the vehicle-mounted device 24.

On the other hand, ordinarily, it is not possible for the first detection range 40L and the second detection range 40R to be simultaneously grasped by the right hand 16R of the driver H while straddling across the upper boundary 42a. Accordingly, when it is detected that both hands of the driver H are in a grasping state, it can be regarded that the left hand 16L is not free. This makes it possible to suppress insofar as possible a situation in which the driver H is capable of operating the vehicle-mounted device 24 during traveling.

Furthermore, on the lower half of the steering wheel 14, the lower boundary 42b between the first detection range 40L and the second detection range 40R is disposed on the side proximate to the vehicle-mounted device 24 with respect to the vertical center line V of the steering wheel 14. In addition, the space S2 of the lower boundary 42b is set to a dimension that is greater than the width T of a first of the left hand 16L of the driver H.

Therefore, the driver H is incapable of grasping the first detection range 40L and the second detection range 40R simultaneously only by the right hand 16R with the lower boundary 42b interposed therebetween. Therefore, it is possible to reliably prevent an erroneous recognition that the steering wheel 14 is being grasped by the left hand 16L, in spite of the fact that the left hand 16L is free.

Further still, on the outer periphery of the steering wheel 14, a plurality of divided leather members are adjacent to each other and wound over a predetermined region, thereby forming the leather layers 38L, 38R. At that time, a conductive paint preferably is applied to each of the leather layers 38L, 38R to thereby constitute a first touch sensor and a second touch sensor in the form of the first contact sensor 18L and the second contact sensor 18R. In addition, an insulating treatment is applied between the leather layers 38L, 38R themselves. In accordance with this feature, the space S1 of the upper boundary 42a is set to a dimension, and more specifically, a narrow dimension, which is less than the width T of a first of the left hand 16L of the driver H.

Moreover, according to the present embodiment, although the steering wheel 14 is a right-hand steering wheel, the present invention is not limited to this feature, and the steering wheel 14 may be a left-hand steering wheel.

In such a case, the one hand of the driver H is the right hand 16R, and the other hand of the driver H is the left hand 16L, while in addition, the second contact sensor 18R that detects contact by the right hand 16R becomes the first contact sensor 18R. On the other hand, the first contact sensor 18L that detects contact by the left hand 16L becomes the second contact sensor 18L. The detection range detected by the first contact sensor 18R is set to be narrower than the detection range detected by the second contact sensor 18L, and as shown by the two-dot dashed lines in FIG. 4, an upper boundary 42c is set to a position capable of being grasped by the right hand 16R. Consequently, similar effects can be obtained in the case that the steering wheel 14 is a right-hand steering wheel, and in the case that the steering wheel 14 is a left-hand steering wheel.

Further, the present invention is not limited to the above-described embodiment, and it goes without saying that various modifications could be adopted therein without departing from the essence and gist of the present invention.

What is claim is:

1. A steering device comprising:
a steering wheel; and
a detection mechanism configured to detect contact by hands of a vehicle occupant over a predetermined region on a circumference of the steering wheel;
wherein the detection mechanism includes:
a first contact sensor provided on a side proximate to a vehicle-mounted device as viewed from a front of the steering wheel, and configured to detect contact by one hand of the vehicle occupant; and
a second contact sensor provided on a side remote from the vehicle-mounted device, and configured to detect contact by another hand of the vehicle occupant;
wherein a first detection range detected by the first contact sensor is set to a region that is narrower than a second detection range detected by the second contact sensor.

2. The steering device according to claim 1, wherein on an upper half of the steering wheel, a boundary between the first detection range and the second detection range is disposed on a side proximate to the vehicle-mounted device with respect to a vertical center line of the steering wheel.

3. The steering device according to claim 1, wherein on a lower half of the steering wheel, a boundary between the first detection range and the second detection range is disposed on a side proximate to the vehicle-mounted device with respect to a vertical center line of the steering wheel.

4. The steering device according to claim 1, wherein:
leather members by which the predetermined region is divided in plurality along the circumference are wound around the steering wheel; and
a conductive paint is applied to each of the leather members, thereby constituting a first touch sensor and a second touch sensor as the first contact sensor and the second contact sensor, respectively.
